(19) United States
(12) Patent Application Publication
(10) Pub. No.: US 2012/0013429 A1
(43) Pub. Date: Jan. 19, 2012

(54) MULTILAYER INDUCTOR AND METHOD OF MANUFACTURING THE SAME

(75) Inventors: Sung Lyoung Kim, Gyeonggi-do (KR); Jin Woo Hahn, Gyeonggi-do (KR); Ic Seob Kim, Gyeonggi-do (KR); Sung Yong An, Gyeonggi-do (KR); Soo Hwan Son, Seoul (KR)

(73) Assignee: SAMSUNG ELECTRO-MECHANICS CO., LTD.

(21) Appl. No.: 12/960,120

(22) Filed: Dec. 3, 2010

(30) Foreign Application Priority Data
Jul. 15, 2010 (KR) 10-2010-0068571

(51) Int. Cl. H01F 5/00; H01F 41/00

(52) U.S. Cl. 336/200; 29/602.1

(57) ABSTRACT

Provided is a multilayer inductor and a method of manufacturing the same. The multilayer inductor includes a plurality of deposited ferrite sheets, a coil part constituted by a plurality of internal electrode patterns and internal electrode vias formed on the plurality of ferrite sheets, non-magnetic vias formed at arbitrary positions of the plurality of ferrite sheets and filled with a non-magnetic material of paste so that a magnetic flux formed around the coil part can be dispersed, and a gap layer formed of a non-magnetic ferrite disposed at a center of the deposited ferrite sheets. Since a non-magnetic via is formed in the multilayer inductor, a magnetic flux propagation path in a coil can be dispersed and blocked to suppress magnetization at a high current and thus improve variation in inductance according to current application.

### CROSS-REFERENCE TO RELATED APPLICATIONS

This application claims the benefit under 35 U.S.C. Section [120, 119, 119(e)] of Korean Patent Application Serial No. 10-2010-0068571, entitled “Multilayer Inductor and Method of Manufacturing the Same” filed on Jul. 15, 2010, which is hereby incorporated by reference in its entirety into this application.

### BACKGROUND OF THE INVENTION

1. Field of the Invention

The present invention relates to a multilayer inductor and a method of manufacturing the same, and more particularly, to a multilayer inductor and a method of manufacturing the same that are capable of dispersing and blocking a magnetic flux in a coil to reduce variation in inductance according to current application of a multilayer power inductor.

2. Description of the Related Art

In general, power inductors are used in power circuits such as DC-DC converters in mobile devices, which have been developed to accomplish miniaturization, high current, low direct current resistance, etc.

As high frequency and miniaturization of the DC-DC converters is accomplished, multilayer power inductors are widely used instead of conventional wound choke coils.

Meanwhile, wound inductors have small variation in inductance according to current application, and effects for implementing the wound inductors in development of multilayer power inductors are ongoing.

For this purpose, composition of materials, fine structures, structural design, and so on, are important factors.

However, the multilayer type has a serious disadvantage of larger variation in inductance according to current application than the wound type.

This is because, in implementing a coil by applying Ag paste on a multilayer power inductor formed of a ferrite sheet, since a magnetic flux is concentrated around Ag and a ferrite sheet magnetic body is rapidly magnetized, variation in inductance of the power inductor is increased under the condition of a large DC-bias.

Therefore, the multilayer power inductor acutely requires improvement of characteristics of the variation in inductance according to current application.

### SUMMARY OF THE INVENTION

Therefore, in order to solve the problems, an aspect of the present invention may be accomplished by providing a multilayer inductor and a method of manufacturing the same that are capable of dispersing and blocking a magnetic flux in a coil by forming a non-magnetic via in the multilayer inductor.

Another aspect of the present invention may be accomplished by providing a multilayer inductor and a method of manufacturing the same that are capable of removing probability of interlayer delamination due to difference in contraction rate upon plastic deformation, which may occur in a multilayer structure during manufacture of the multilayer inductor.

In order to accomplish the above and other aspects, the present invention provides a multilayer inductor including a plurality of deposited ferrite sheets; a coil part constituted by a plurality of internal electrode patterns and internal electrode vias formed on the plurality of ferrite sheets; non-magnetic vias formed at arbitrary positions of the plurality of ferrite sheets and filled with a non-magnetic material of paste so that a magnetic flux formed around the coil part can be dispersed; and a gap layer formed of a non-magnetic ferrite disposed at a center of the deposited ferrite sheets.

In addition, the at least one non-magnetic via may be disposed inside or outside the coil part.

The non-magnetic vias are disposed adjacent to the coil part so that a magnetic field formed around the coil part is dispersed.

Meanwhile, the non-magnetic ferrite of the gap layer may use a Cu-based ferrite and the Cu may be substituted at a ratio of 0.1 mol % or less.

The non-magnetic vias may be filled with ceramic.

The paste of the non-magnetic vias may be formed of a non-magnetic powder including Fe₂O₃ 50 to 48%, ZnO 40 to 38%, and CuO 12 to 10%.

In addition, the non-magnetic vias may be formed through laser punching or mechanical punching.

The non-magnetic vias may have a diameter of 100 μm or less and a column shape.

The coil part may be filled with Ag paste.

The internal electrode patterns and the internal electrode vias for the coil part may be formed at least one of the plurality of ferrite sheets.

The present invention also provides a multilayer inductor including a plurality of deposited ferrite sheets; a coil part constituted by a plurality of internal electrode patterns and internal electrode vias formed on the plurality of ferrite sheets; and non-magnetic vias formed at arbitrary positions of the plurality of ferrite sheets and filled with a non-magnetic material of paste so that a magnetic flux formed around the coil part can be dispersed.

In addition, the at least one non-magnetic via may be disposed inside or outside the coil part.

The non-magnetic vias may be disposed adjacent to the coil part so that a magnetic field formed around the coil part is dispersed.

In addition, the non-magnetic vias may be filled with ceramic.

Meanwhile, the paste of the non-magnetic vias may be formed of a non-magnetic powder including Fe₂O₃ 50 to 48%, ZnO 40 to 38%, and CuO 12 to 10%.

The non-magnetic vias may be formed through laser punching or mechanical punching.

In addition, the non-magnetic vias may have a diameter of 100 μm or less and a column shape.

The coil part may be filled with Ag paste.

The internal electrode patterns and the internal electrode vias for the coil part may be formed at least one of the plurality of ferrite sheets.

The present invention also provides a method of manufacturing a multilayer inductor including: manufacturing a non-magnetic material of paste; forming via-holes filled with the non-magnetic material of paste at pre-designated positions of a plurality of ferrite sheets, which is to be deposited; filling the non-magnetic material of paste into the via-holes; depositing the plurality of ferrite sheets; and performing a plasticization and external electrode forming process and performing plating.

In addition, the method of manufacturing a multilayer inductor may further include manufacturing Ag paste; forming via-holes for Ag paste at pre-designated positions of the plurality of ferrite sheets, which is to be deposited; and filling Ag paste into the via-holes for Ag paste to form a coil part.

Further, at least one via-hole filled with a non-magnetic material of paste may be formed inside or outside the coil part to be filled with the non-magnetic material of paste.

The via-holes filled with the non-magnetic material of paste may be disposed adjacent to the coil part so that a magnetic field formed around the coil part is dispersed.

In addition the non-magnetic material of paste may be formed of ceramic.

The non-magnetic material of paste may be formed of a non-magnetic powder including Fe₂O₃ 50 to 48%, ZnO 40 to 38%, and CuO 12 to 10%.

The via-holes filled with the non-magnetic material of paste may be formed through laser punching or mechanical punching.

In addition, the method of manufacturing a multilayer inductor may further include depositing a gap layer formed of a non-magnetic material at a center of the plurality of ferrite sheets.

The non-magnetic ferrite of the gap layer may use a Cu-based ferrite and the Cu may be substituted at a ratio of 0.1 mol % or less.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a plan view showing an example of a multilayer inductor in accordance with the present invention;

FIG. 2 is a cross-sectional view of the multilayer inductor taken along line I-I′ of FIG. 1; and

FIG. 3 is a plan view showing another example of the multilayer inductor in accordance with the present invention.

### DETAILED DESCRIPTION OF THE PREFERABLE EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

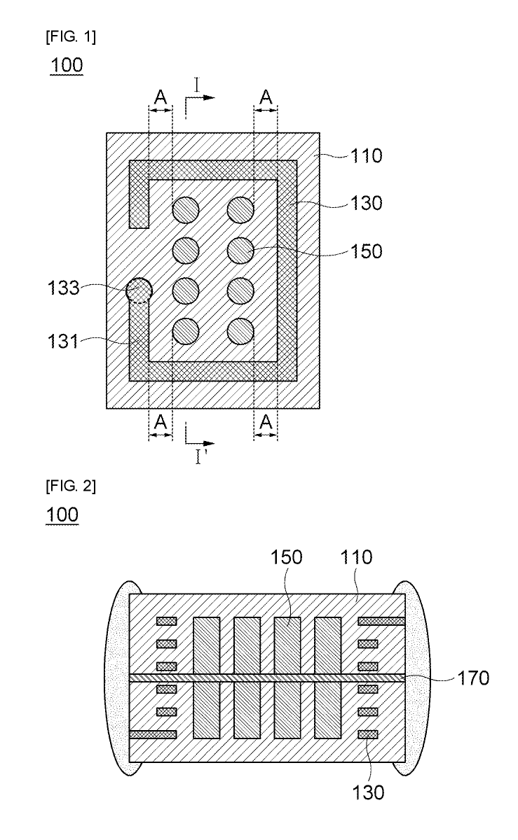

FIG. 1 is a plan view showing an example of a multilayer inductor in accordance with the present invention, which will be described with reference to FIG. 2 showing a cross-sectional view of the multilayer inductor taken along line I-I′ of FIG. 1.

As shown, a multilayer inductor 100 in accordance with the present invention includes a ferrite sheet 110, a coil part 130, a non-magnetic via 150, and a gap layer 170.

More specifically, as shown in FIG. 2, the ferrite sheet 110 may be formed in a shape in which a plurality of ferrite sheets are deposited.

In addition, the ferrite sheets 110 may include an internal electrode pattern 131 and an internal electrode via 133 for the coil part 130 formed on the plurality of ferrite sheets 110.

Meanwhile, the ferrite sheet 110, in which the plurality of sheets are deposited, may include the internal electrode pattern 131 and the internal electrode via 133 for the coil part 130 formed on at least one of the plurality of ferrite sheets. It means that the coil part 130 may be formed on some of the ferrite sheets.

Next, the coil part 130 may include a plurality of internal electrode patterns 131 and a plurality of internal electrode vias 133 formed on the plurality of ferrite sheets 110.

For example, as shown in FIG. 1, when the multilayer inductor 100 is seen from a plan view, the coil part 130 may include the internal electrode pattern 131 formed in a hollow rectangular shape, a portion of which is open, and the internal electrode via 133 formed at one of both ends of the internal electrode pattern 131.

Meanwhile, the coil part 130 may be filled with Ag paste.

The non-magnetic via 150 may be formed at an arbitrary position of the plurality of ferrite sheets to be filled with non-magnetic paste so that a magnetic flux can be dispersed around the coil part 130.

Here, at least one non-magnetic via 150 may be disposed inside or outside the coil part 130.

For example, as shown in FIG. 1, two rows of non-magnetic vias 150 may be disposed inside the coil part 130, or a plurality of non-magnetic vias 150 may be disposed outside the coil part 130 to surround the coil part 130.

Here, the non-magnetic vias 150 may be disposed adjacent to the coil part 130 (an interval A of FIG. 1) such that the magnetic flux formed around the coil part can be dispersed.

This is because the magnetic flux dispersion ability of the coil part 130 is improved as a distance between the non-magnetic cores 150 and the coil part 130 is reduced.

Meanwhile, the non-magnetic cores 150 may be filled with ceramic.

In addition, the paste of the non-magnetic cores 150 maybe formed of a non-magnetic powder including Fe₂O₃ 50 to 48%, ZnO 40 to 38%, and CuO 12 to 10%.

The non-magnetic cores 150 may be formed through laser punching or mechanical punching.

Further, the non-magnetic cores 150 may have a diameter of 100 μm, but it is not limited thereto.

For example, the non-magnetic vias 150 may have a diameter of 70 to 150 μm.

The non-magnetic vias 150 having the above size may have a column shape when seen from a cross-sectional view of the multilayer inductor 100. Therefore, it may be possible to solve an interlayer delamination phenomenon, which may occur from the multilayer structure formed of different materials.

While the present invention describes the non-magnetic vias 150 only, various shapes of modifications formed of a non-magnetic material may be made to disperse the magnetic flux of the coil part 130, in addition to the via-shape, depending on necessity of an operator.

In addition, the non-magnetic vias 150 may be formed on all of the plurality of ferrite sheets to pass through upper and lower parts of the multilayer inductor, when seen from a cross-sectional view.

The gap layer 170 may be disposed at a center of the deposited ferrite sheets and may be formed of a non-magnetic ferrite.

For example, as shown in FIG. 2, the gap layer 170 may be disposed to be inserted into a center portion of the plurality of deposited ferrite sheets.

Here, the gap layer 170 can disperse a certain level of magnetic flux of the coil part 130.

The ferrite sheet of the gap layer 170 may be formed of a Zn-based ferrite, which may be substituted with a Cu-based ferrite. Here, Cu may be substituted at a ratio of 0.1 mol % or less.

For example, the non-magnetic ferrite of the gap layer 170 may be a ZnFe₂O₄ ferrite, in which Zn may be substituted with Cu at a ratio of 0.1 mol % or less.

Meanwhile, although the multilayer inductor 100 in accordance with the present invention has been described to include the plurality of ferrite sheets 110, the coil part 130 formed by filling an Ag conductor into vias formed in the ferrite sheets 110, the non-magnetic vias 150 filled with paste formed of a non-magnetic ceramic powder, etc., and the gap layer 170, the multilayer inductor 100 may be constituted by some of the above-mentioned components depending on necessity of those skilled in the art.

For example, the multilayer inductor 100 may be constituted by the other components, except for the gap layer 170.

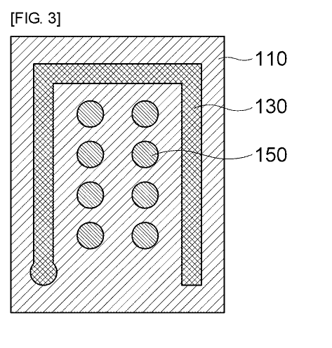

Meanwhile, as shown in FIG. 3, in the rectangular shape in which a center of the coil part 130 including the internal electrode 131 and the internal electrode via 133 formed in the multilayer inductor is empty, the coil part 130 may be open at another surface different from FIG. 1.

The pattern of the coil part 130 is not limited to the shapes of FIGS. 1 and 3 but may be opened at another surface or formed in various shapes, in addition to the rectangular shape.

While not shown, the multilayer inductor 100 in accordance with the present invention may be manufactured through the following processes.

First, a non-magnetic material of paste and Ag paste may be manufactured.

Then, non-magnetic via-holes may be formed in pre-designated positions of the plurality of ferrite sheets, which will be deposited, to be filled with a non-magnetic material of paste.

In addition, via-holes for Ag paste may be formed in pre-designated positions of at least one ferrite sheet, among the plurality of ferrite sheets, which will be deposited.

This is because the via-holes for Ag paste may be formed in some of the plurality of ferrite sheets.

The non-magnetic material of paste is filled into the formed via-holes, and then, Ag paste is filled into the via-holes for Ag paste, forming the coil part 130.

The non-magnetic vias 150 may be formed at arbitrary positions of the plurality of ferrite sheets to be filled with a non-magnetic material of paste so that a magnetic flux formed around the coil part 130 can be dispersed.

Here, at least one non-magnetic via 150 may be disposed inside or outside the coil part 130.

For example, as shown in FIG. 1, two rows of non-magnetic vias 150 may be disposed inside the coil part 130 or a plurality of non-magnetic vias 150 may be disposed outside the coil part 130 to surround the coil part 130.

Here, the non-magnetic vias 150 may be disposed to be spaced apart from the coil part 130 by an arbitrary interval A or less. This is because a magnetic flux dispersion ability of the coil part 130 can be improved as a distance between the non-magnetic vias 150 and the coil part 130 is reduced.

Meanwhile, the non-magnetic vias 150 may be filled with ceramic.

In addition, the paste of the non-magnetic vias 150 may be formed of a non-magnetic powder including Fe₂O₃ 50 to 48%, ZnO 40 to 38%, and CuO 12 to 10%.

The non-magnetic vias 150 may be formed through laser punching or mechanical punching.

Further, the non-magnetic vias 150 may be formed to have a diameter of 100 μm or less, but it is not limited thereto.

For example, the non-magnetic vias 150 may have a diameter of 70 to 150 μm.

The non-magnetic vias 170 having the above-mentioned size may be formed in a column shape when seen from a cross-sectional view of the multilayer inductor.

Here, the coil part 130 may be constituted by a plurality of internal electrode patterns 131 and internal electrode vias 133 formed on the plurality of ferrite sheets 110.

Next, the plurality of ferrite sheets may be deposited.

In addition, a general plasticization and external electrode forming process may be performed, and plating may be performed.

Meanwhile, the process may further include depositing the gap layer 170 formed of a non-magnetic material to be disposed on a center of the deposited ferrite sheet.

The gap layer 170 may be formed of a non-magnetic ferrite disposed at a center of the deposited ferrite sheets.

For example, as shown in FIG. 2, the gap layer 170 may be disposed to be inserted into a center portion of the plurality of deposited ferrite sheets.

Here, the gap layer 170 can disperse a certain level of magnetic flux of the coil part 130.

In addition, the ferrite sheet of the gap layer 170 may be formed of a Zn-based ferrite, which may be substituted with a Cu-based ferrite. Here, Cu may be substituted at a ratio of 0.1 mol % or less.

For example, the non-magnetic ferrite of the gap layer 170 may be a ZnFe₂O₄ ferrite, in which Zn may be substituted with Cu at a ratio of 0.1 mol % or less.

As apparent from the above description, in the multilayer inductor and the method of manufacturing the same, since a non-magnetic via is formed in the multilayer inductor, a magnetic flux propagation path in a coil can be dispersed and blocked to suppress magnetization at a high current and thus improve variation in inductance according to current application.

In addition, since a column-type of non-magnetic via is formed in the multilayer inductor, it is possible to solve an interlayer delamination phenomenon which may occur in a multilayer structure formed of different materials.

Further, it is possible to adjust a contraction rate of ceramic paste to control stress in the inductor.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A multilayer inductor comprising:
a plurality of deposited ferrite sheets;
a coil part constituted by a plurality of internal electrode patterns and internal electrode vias formed on the plurality of ferrite sheets;
non-magnetic vias formed at arbitrary positions of the plurality of ferrite sheets and filled with a non-magnetic material of paste so that a magnetic flux formed around the coil part can be dispersed; and
a gap layer formed of a non-magnetic ferrite disposed at a center of the deposited ferrite sheets.

2. The multilayer inductor according to claim 1, wherein the at least one non-magnetic via is disposed inside or outside the coil part.

3. The multilayer inductor according to claim 2, wherein the non-magnetic vias are disposed adjacent to the coil part so that a magnetic field formed around the coil part is dispersed.

4. The multilayer inductor according to claim 1, wherein the non-magnetic ferrite of the gap layer uses a Cu-based ferrite and the Cu is substituted at a ratio of 0.1 mol % or less.

5. The multilayer inductor according to claim 1, wherein the non-magnetic vias are filled with ceramic.

6. The multilayer inductor according to claim 1, wherein the paste of the non-magnetic vias is formed of a non-magnetic powder including Fe₂O₃ 50 to 48%, ZnO 40 to 38%, and CuO 12 to 10%.

7. The multilayer inductor according to claim 1, wherein the non-magnetic vias are formed through laser punching or mechanical punching.

8. The multilayer inductor according to claim 1, wherein the non-magnetic vias have a diameter of 100 μm or less and a column shape.

9. The multilayer inductor according to claim 1, wherein the coil part is filled with Ag paste.

10. The multilayer inductor according to claim 1, wherein the internal electrode patterns and the internal electrode vias for the coil part are formed at least one of the plurality of ferrite sheets.

11. A multilayer inductor comprising:
a plurality of deposited ferrite sheets;
a coil part constituted by a plurality of internal electrode patterns and internal electrode vias formed on the plurality of ferrite sheets; and
non-magnetic vias formed at arbitrary positions of the plurality of ferrite sheets and filled with a non-magnetic material of paste so that a magnetic flux formed around the coil part can be dispersed.

12. The multilayer inductor according to claim 11, wherein the at least one non-magnetic via is disposed inside or outside the coil part.

13. The multilayer inductor according to claim 12, wherein the non-magnetic vias are disposed adjacent to the coil part so that a magnetic field formed around the coil part is dispersed.

14. The multilayer inductor according to claim 11, wherein the non-magnetic vias are filled with ceramic.

15. The multilayer inductor according to claim 11, wherein the paste of the non-magnetic vias is formed of a non-magnetic powder including Fe₂O₃ 50 to 48%, ZnO 40 to 38%, and CuO 12 to 10%.

16. The multilayer inductor according to claim 11, wherein the non-magnetic vias are formed through laser punching or mechanical punching.

17. The multilayer inductor according to claim 11, wherein the non-magnetic vias have a diameter of 100 μm or less and a column shape.

18. The multilayer inductor according to claim 11, wherein the coil part is filled with Ag paste.

19. The multilayer inductor according to claim 11, wherein the internal electrode patterns and the internal electrode vias for the coil part are formed at least one of the plurality of ferrite sheets.

20. A method of manufacturing a multilayer inductor comprising:
manufacturing a non-magnetic material of paste;
forming via-holes filled with the non-magnetic material of paste at pre-designated positions of a plurality of ferrite sheets, which is to be deposited;
filling the non-magnetic material of paste into the via-holes;
depositing the plurality of ferrite sheets; and
performing a plasticization and external electrode forming process and performing plating.

21. The method of manufacturing a multilayer inductor according to claim 20, further comprising:
manufacturing Ag paste;
forming via-holes for Ag paste at pre-designated positions of the plurality of ferrite sheets, which is to be deposited; and
filling Ag paste into the via-holes for Ag paste to form a coil part.

22. The method of manufacturing a multilayer inductor according to claim 21, wherein at least one via-hole filled with the non-magnetic material of paste is formed inside or outside the coil part to be filled with the non-magnetic material of paste.

23. The method of manufacturing a multilayer inductor according to claim 22, wherein the via-holes filled with the non-magnetic material of paste are disposed adjacent to the coil part so that a magnetic field formed around the coil part is dispersed.

24. The method of manufacturing a multilayer inductor according to claim 21, wherein the non-magnetic material of paste is ceramic.

25. The method of manufacturing a multilayer inductor according to claim 21, wherein the non-magnetic material of paste is formed of a non-magnetic powder including Fe₂O₃ 50 to 48%, ZnO 40 to 38%, and CuO 12 to 10%.

26. The method of manufacturing multilayer inductor according to claim 21, wherein the via-holes filled with the non-magnetic material of paste are formed through laser punching or mechanical punching.

27. The method of manufacturing a multilayer inductor according to claim 21, further comprising depositing a gap layer formed of a non-magnetic material at a center of the plurality of ferrite sheets.

28. The method of manufacturing a multilayer inductor according to claim 27, wherein the non-magnetic ferrite of the gap layer uses a Cu-based ferrite and the Cu is substituted at a ratio of 0.1 mol % or less.
